(19) United States
(12) Patent Application Publication
(10) Pub. No.: US 2025/0348748 A1
(43) Pub. Date: Nov. 13, 2025

(54) SYSTEM AND METHOD FOR REINFORCEMENT LEARNING BASED ON PRIOR TRAJECTORIES

(71) Applicant: DeepMind Technologies Limited, London (GB)

(72) Inventors: Jacob Bruce, London (GB); Ankit Anand, Brossard (CA); Robert David Fergus, New York, NY (US)

(21) Appl. No.: 18/867,094

(22) PCT Filed: Sep. 27, 2023
(86) PCT No.: PCT/EP2023/076793

§ 371 Date: Nov. 19, 2024

Related U.S. Application Data
(60) Provisional application No. 63/410,925, filed on Sep. 28, 2022.
(60) Provisional application No. 63/441,395, filed on Jan. 26, 2023.

(51) Int. Cl. G06N 3/092; G06N 3/082

(52) U.S. Cl. CPC G06N 3/092; G06N 3/082

(57) ABSTRACT

A reinforcement learning system is proposed in which a policy model neural network is trained to control an agent to perform a task in successive time steps, by training a control system including the policy model neural network to select a respective action for each time step which gives a high value for a reward function based on the action, and which indicates the contribution of the action to solving the task. The reward function includes a term based on a progress value output by a progress model. The progress model generates the progress value upon receiving a first observation of the state of the environment at a time step before the performance of the action, and a second observation of the state of the environment at a time step following the performance of the action. The progress value is an estimate of the average time which an ensemble of experts who produced the demonstrations would have taken to transform the environment from how it appears in the first observation to how it appears in the second observation.

### CROSS-REFERENCE TO RELATED APPLICATION

This application claims priority to U.S. Provisional Applications No. 63/410,925, filed on Sep. 28, 2022, and No. 63/441,395, filed on Jan. 26, 2023. The disclosure of the prior applications is considered part of and is incorporated by reference in the disclosure of this application.

### BACKGROUND

This specification relates to methods and systems for training a neural network to choose actions to be performed by an agent in an environment.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification generally describes how a system implemented as computer programs in one or more computers in one or more locations can perform a method to train (that is, adjust the parameters of) an adaptive system (“neural network”) used to select actions to be performed by an agent interacting with an environment.

In broad terms a reinforcement learning (RL) system is a system that selects actions to be performed by a reinforcement learning agent, or simply agent, interacting with an environment. In order for the agent to interact with the environment, the system receives data characterizing the current state of the environment and selects an action to be performed by the agent in response to the received data. Data characterizing (at least partially) a state of the environment is referred to in this specification as “state data”, or an “observation”. The environment may be a real-world environment, and the agent may be an agent which operates on the real-world environment. Alternatively, the environment may be a simulated environment. Thus the term “agent” is used to embrace both a real-world agent (e.g. a robot) and a simulated agent, and the term “environment” is used to embrace both types of environment.

In general terms, the disclosure proposes a reinforcement learning system in which a policy model neural network is trained to control an agent to perform a task in successive time steps, by training a control system (“action selection system”) including the policy model neural network to select a respective action for each time step which gives a high value for a reward function based on the action, and which indicates the contribution of the action to solving the task. The reward function includes a reward term (an “exploration reward term”) based on a progress value which is the output of a progress model. The progress model generates the exploration reward term upon receiving an observation of the state of the environment at a time step following the performance of the action, and an observation of the state of the environment at a time step before the performance of the action (e.g. an observation using which the control system selected the action; but other possibilities are discussed below).

The progress model is one which has previously been trained using a database of trajectories (that is, sequences of observations of the environment at corresponding time steps during a period in which the task was performed; for example (but not necessarily) by controlling agent to perform the task). These trajectories (which may be called “expert trajectories”) may for example each be successive observations at a sequence of corresponding time steps during a period in which an expert (typically, but not necessarily, a human expert) performed the task, e.g. by controlling an agent to perform the task. The progress model was trained to output, upon receiving a pair of observations from one of the trajectories, a “progress value” which is a measure of the time difference between the corresponding time steps. The exploration reward term is higher in the case that the output of the progress model is a progress value which the progress model typically outputs upon receiving a pair of observations from one of the trajectories which are a high number of time steps apart.

Since each of the trajectories is an attempt to solve the model, the fact that the two observations are a high number of time-steps apart suggests (if the expert is at all skillful at performing the task) that significant progress towards solving the task was probably made between the pair of observations. Thus, when the exploration reward term for a given action is high, this is statistically associated with the case that the action makes a significant contribution to solving the task.

A specific expression of present disclosure is a computer-implemented method of training a policy model neural network to generate control data for controlling an agent interacting with an environment to perform a task,
the method employing:
a database of training data which comprises a plurality of trajectories, each trajectory comprising a sequence of observations characterizing consecutive states of the environment at corresponding time steps during a performance of the task, and
a progress model configured to generate an output upon receiving two observations as inputs;
the method comprising:
based on the training data, training the progress model to output, upon receiving as inputs a pair of observations from one of the trajectories, a progress value indicative of the time difference between the corresponding time steps; and
training the policy model neural network by, at successive time steps, selecting corresponding actions for the agent to perform using the policy model neural network, and adjusting parameters of the policy model neural network based on reward values associated with the actions selected using the policy model neural network, each reward value being the value of a reward function which includes an exploration reward term based on a progress value output by the trained progress model upon receiving as inputs a pair of observations characterizing the state of the environment at corresponding time steps which are respectively before and after the performance of the action by the agent.

For example, the time step after the performance of the action by the agent may be the observation for the immediately succeeding time step after the time step in which the action is selected.

The progress value may be considered to be an estimate of the average time which the ensemble of experts who produced the demonstrations would have taken to transform the environment from how it appears in the first observation of the pair to how it appears in the second observation of the pair.

The reward function may include one or more additional reward terms, for example type(s) of reward terms which are known in the reinforcement learning literature. For example, it is known for an action to be associated with an “extrinsic” reward term which compares the observation after the action is taken with one or more (predetermined) criteria which define the task, to determine whether the task has been completed by the action. The extrinsic reward term may for example take a first value (e.g. a high value) when the one or more criteria are met, or a second value (e.g. a low value) when the one or more criteria are not met. More generally, the extrinsic reward term is a function of which of the criteria are met.

Alternatively or additionally, the reward function may include one or more reward terms, e.g. of types presently known in the reinforcement learning field, which encourage exploration of the environment. For example, the evaluation of the reward function may include evaluating a measure of similarity of the observation after the performance of the action by the agent (e.g. the observation for the immediately succeeding time step after the time step in which the action is selected) and a database of observations (e.g. observations collected earlier in the same sequence of time steps, and/or observations collected on previous occasions when the policy network attempted to control the agent to perform the task), and the reward function may include a reward term which takes a high value when the similarity measure is low, implying that the action has caused the environment to enter a state which, according to the similarity measure, is very different from those previously explored.

In any of these situations, the exploration reward term can be understood as providing a bias in the reward function. The bias is such as to encourage the modification to the policy model neural network, which increases the value of the reward function, to make the policy model neural network more likely to choose an action which changes the environment in substantially the same way that it is changed during the trajectories in the database.

The training of the progress model is typically carried out before the training of the policy model neural network, e.g. completed before the training of the policy model begins. For many databases plentiful databases exist of human agents performing the task, and such databases may be used to train the progress model.

The training of policy model neural network may be performed online. That is, during the process of training the policy model neural, there may be one or more episodes in each of which a sequence of actions is selected by the evolving action selection system at successive time steps based on an observation of the state of the environment at that time step and performed by the agent at that time step. The observations of the state of the environment are collected, rewards as described above are associated with the actions are obtained, and the data about the actions, observations and rewards are added to the training database.

Alternatively, in principle the training of the policy model neural network may be performed based on (e.g. known) off-line reinforcement learning techniques using a database of trajectories (sequences of corresponding states, actions and rewards as described above) which is not supplemented by new trajectories during the process of training the policy model neural network.

The subject matter described in this specification can be implemented in particular embodiments so as to realize one or more of the following advantages.

Firstly, as explained, the exploration reward term biases the policy model neural network to choose actions which are statistically likely to eventually perform the task. This is true even if the extrinsic reward function provides extremely sparse rewards (e.g. the extrinsic reward function is zero unless a very long sequence of appropriate actions is taken). Extremely sparse rewards are typical of many agent control tasks, and are challenging for existing reinforcement learning systems. Thus, for such tasks the present subject matter can lead to highly successful performance of tasks which cannot be learnt by some known reinforcement learning techniques, or to performance which is faster (e.g. consumes less agent time and/or computing time) than using other known reinforcement learning tasks.

Secondly, the subject matter makes use of a database of trajectories even in the case that the trajectories are not, in fact, efficient ways of performing the task, e.g. trajectories in which the human expert makes many mistakes when solving the task and has to correct those mistakes before the task is solved. Learning from databases of expert trajectories is known as “imitation learning”. Many known imitation learning techniques teach a policy model neural network to imitate trajectories in which an agent was controlled by a human expert, but even if this is successful the resulting policy model neural network does not typically control the agent in a way which is more skillful than the human expert, because the policy model neural network is trained to emulate the human experts' missteps as well as their successes. By contrast, the present subject matter provides a way to bias the learning such that the policy model neural network is encouraged to select actions to emulate the long-term achievements of the human experts, after they have corrected their mistakes. Experimentally it has been confirmed that for difficult tasks, policy model neural networks trained according to the present procedure can perform at a level far above that of the human experts for difficult learning problems, e.g. learning to perform tasks in many fewer time steps than a human expert.

Thirdly, the subject matter provides a way of adapting known policy model neural network training methods based on an extrinsic reward term to benefit from the database of expert trajectories, and thereby benefit from some of the advantages of imitation learning, such as more rapid improvement in the first phases of training the policy model neural network.

Fourthly, the present subject matter does not, in many embodiments, require action data associated with expert trajectories. This means that it can be used even when this data is not available, e.g. because, in some or all of the trajectories, the experts performed the task by manipulating tools in the real world, rather than issuing control instructions to an agent; and/or because some or all of the trajectories were performed by controlling an agent different from the agent which is to be controlled by the policy network. For the same reason, the present techniques may be used even when the trajectories have different sources, e.g. different ones of the trajectories were generated by different humans controlling different sorts of agent (or without controlling agents) using different control interfaces.

The policy model training method used to train the policy model neural network based on the reward values may be any method of training a policy model based on reward values associated with actions. The presently proposed exploration reward term provides a bias to one of these known learning techniques, analogous to the additional terms which some known reinforcement learning algorithms use to train a policy model neural network to learn together a main task and one or more auxiliary tasks. Many policy model neural network training methods based on reward values are known in the literature. They vary iteratively a set of parameters ϕ which define the function performed by the policy model neural network, denoted π_{ϕ}. For example, the set of parameters ϕ may comprise weights and/or bias values of neural units, each of which is located in one of the layers of the policy model neural network, and which generates an output as a function (e.g. a non-linear function) of a weighted sum of the inputs to the neural unit plus a bias value. As explained below, the inputs to the policy model neural network comprise the observation s, but may further comprise an action a which the agent may take in response to the observation s.

For example, the policy model training method may just be a “direct policy search” method, in which the parameters ϕ are varied to maximize the average value of a reward function for an action a which is an output π_{ϕ}(s) of the policy model neural network, where s denotes the observation of the current state of the environment received by the policy model neural network. For example, the policy model neural network may be trained to generate a “one hot” output having a respective component for each action the policy model neural network may perform, and the action a may be defined as the action for which the corresponding component of π_{ϕ}(s) is highest, or by applying a soft max function to π_{ϕ}(s).

In another case, the policy model training method may train a policy model neural network to receive input action a and an observation s current state of the environment, and to output a value π_{ϕ}(s, a) which is an estimate of the contribution of the action a to performing the task. Examples of such a policy model training method include the many algorithms referred to as Q-learning methods, such as Mnih, V. et al. “Human-level control through deep reinforcement learning”. Nature, 518(7540):529-533, 2015. Q-learning is a model free method of producing a value function, but other policy model training methods based on reward values generate a model of their environment, and the present techniques are applicable in this case too.

In such cases, the policy model neural network may define, for any observed state of the environment characterized by an observation s received by the policy model neural network, a “state-action distribution” over the set of possible actions the agent can perform. In other words, the policy model neural network, conditioned on an observation s of the environment characterizing the state of the environment, assigns (e.g. successively) a corresponding numerical value to each possible action, and the numerical values are used to select the action of the agent. In some cases, the action may be selected to be the action which has the highest numerical value. In other case, a probability distribution may be defined based on the state-action distribution, and the action to be performed by the agent may be selected randomly from the distribution. In yet other cases, the action may be selected in one of these ways with a probability which is a scalar value ∈, and with a probability which is 1-∈ the action is chosen at random.

The parameters of the progress model (which may be another multi-layer neural network, such as a feed forward multilayer network) may be denoted θ, and may likewise be weights and/or bias values. For example, the set of parameters θ may comprise weights and/or bias values of neural units, each of which is located in one of the layers of the progress model, and which generates an output as a function (e.g. a non-linear function) of a weighted sum of the inputs to the neural unit plus a bias value.

The progress model training method used to train the progress model may likewise be any known supervised learning method, such as a backpropagation method to minimize a difference between the output of the progress model upon receiving two observations from one of the trajectories in the database, and the desired value indicative of the time difference (number of time steps) between the two observations.

Optionally, the progress value indicative of the time difference is proportional to a logarithmic function of the time difference. Particularly in this case, the exploration reward term may be an exponential function of the progress value output by the progress model upon receiving the pair of observations.

During the training of the policy model neural network, the pair of observations which are input to the progress model to generate the progress value for a given action typically include the first observation after the action has been performed. The other observation of the pair, i.e. the observation of the state at a time before the action was performed, may be chosen in various ways. It may for example be the observation for an initial state of the environment, i.e. before any actions selected by the policy neural network are selected. Alternatively, it may, e.g. for all policy model training iterations, be the state of the environment for a second time step which is a predetermined number of time steps k before the time step corresponding to the other observation of the pair. Experimentally is has been found to be preferable if k is greater than one. This may for example encourage sequences of successive actions which, in combination, contribute to solving a task, even though individually they may not.

In some cases, raw observations collected during the periods in which the trajectories of the database occurred include data which is uninformative about how to perform the task but which contains information about the corresponding time steps (i.e. each observation may include information indicating its position in the trajectory). For example, in the case that the observations are captured images of the environment, the captured images may include an image of a clock in the environment, so that successive images of a given trajectory show the clock advancing as time passes. If the progress model learns to rely on data of this kind, then the progress values will be less informative about the performance of the task. For this reason, the method may include a step of filtering (i.e. making unavailable to the progress model) the observations in the training data, prior to generating the progress model, to remove data which is indicative of the corresponding time step (position of the observation in the trajectory) but uninformative about how to perform the task (e.g. removing the part of the image showing the clock). That is, the filtration removes, from the observation data which is input the progress model during the training of the progress model, data which is uninformative about how to perform the task but informative about the time step. The filtration may be performed manually or by an automatic method, e.g., automatically removing metadata or other data, e.g., images of a clock, or time stamps generated by a camera and included in images within the observations.

Once the policy model neural network has been trained, it may be used to control an agent to perform the task while interacting with the environment based on observations of the environment, by using the trained policy model neural network to select actions to control the agent to perform the task. Note that optionally the training may be performed using trajectories generated using a simulation of a real-world environment (i.e. a simulated agent performs actions in a simulated environment which simulates a real world environment) for greater speed and/or reduced costs, including reduced wear to the agent, and the trained policy model neural network may then be used to control a real world agent in the real world environment.

The policy model neural network and the progress network may take any conventional neural network form. For example, either or both could be a feed forward network (e.g. comprising a sequence of layers, including a plurality of nodes in each layer, with outputs of each layer (except the first layer of the sequence) being inputs to the next layer), and either or both may comprise one or more convolutional layers, particularly in the case that the observations are in the form of still or moving images as described below.

Optionally, either or both of the policy model neural network and the process model may comprise an encoder for generating an encoded representation of each (e.g. filtered) observation it receives. The encoded representation may have a smaller data size than the observation (e.g. as measured by the number of bits respectively in the encoded representation and the observation), thus reducing the dimensionality of data which the policy model neural network and progress model process subsequently to generate their respective outputs. Specifically, the policy model neural network may comprise a policy model encoder configured, upon receiving an observation, to form an encoded representation of the observation, and the policy model neural network may generate the output of the policy model neural network based on the encoded representation. Similarly, the progress model may comprise a progress model encoder configured, upon receiving two observations, to form two respective encoded representations of each of the two observations, the progress model generating the progress value based on the two encoded representations. In implementations, the same encoder may be shared by the policy model neural network and the progress model, i.e. play the role of both the policy model encoder and the progress model encoder.

The policy model encoder and/or progress model encoder may be trained in an encoder training process. This, like the training of the progress model, may be performed before the “online” training of the policy model neural network described above, e.g. at a time when it is not practical to collect data by using the policy model neural network, as it is being trained, to select actions for the agent to perform based on current observations, and to collect the corresponding subsequent observations of the subsequent state of the environment and the corresponding rewards.

Conveniently, the encoder training process may comprise an iterative process in which, at each iteration, a modification is made to the encoder to increase the value of an encoder reward function. The encoder reward function may be evaluated, for a given state of the encoder, by a process of training a prediction model, upon receiving encoded representations produced by the encoder of two observations from the training database, to optimize the success rate of a model which is trained, upon receiving encoded representations, produced by the policy model encoder, of two (e.g. filtered) observations selected from the training database, to predict whether the two observations are observations which are part of the same trajectory and have a time difference between their respective time steps which meets a criterion. For example, the criterion may be that the time difference is within a certain predefined range. The encoder reward function may be a function of (e.g. equal to) the expectation value of the success rate of the trained predictive model upon receiving two observations. This success rate may be evaluated by randomly selecting pairs of observations, inputting pairs to the prediction model, and determining the proportion of pairs for which the output of the prediction model (e.g. a binary output) successfully indicates whether the pair of observations are observations which are part of the same trajectory and have a time difference between their respective time steps which meets the criterion. Note that the prediction model doing this successfully is facilitated by the encoded representation of the observation preserving and distilling information in the observations relevant to performing the task. Thus, the encoder, like the progress model, benefits from the expert trajectories performed by the human experts.

The concepts of the present disclosure may alternatively be expressed as a system comprising one or more computers and one or more storage devices storing instructions that when executed by the one or more computers cause the one or more computers to perform the method described above.

In another option, the concepts of the present disclosure may be expressed as one or more computer storage media storing instructions that when executed by one or more computers cause the one or more computers to perform the method, and thereby implement the system.

In another option, the concepts of the present disclosure may be expressed as an agent (e.g. a mechanical agent, such as a robot) comprising (e.g. in a control unit of the agent) a policy model neural network trained to select actions to be performed by the agent to control the agent to perform the learned task in an environment, wherein the policy model neural network has been trained as explained above.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example action selection system.

FIG. 2 shows a system for training a progress model.

FIG. 3 shows a reward calculation unit incorporating the progress model of FIG. 3 and for use in the action selection system of FIG. 1.

FIG. 4 shows an example training method.

FIGS. 5, 6 and 7 show experimental results from an implementation of the method of FIG. 4 for three respective tasks.

FIG. 8 shows an offline training system for a policy neural network of an action selection system.

FIG. 9 shows an offline training system for training an encoder.

FIG. 10 shows a policy model neural network incorporating a trained encoder.

FIG. 11 shows a progress model incorporating a trained encoder.

FIG. 12 shows a robot employing a control system.

Like reference numbers and designations in the various drawings indicate like elements.

### DETAILED DESCRIPTION

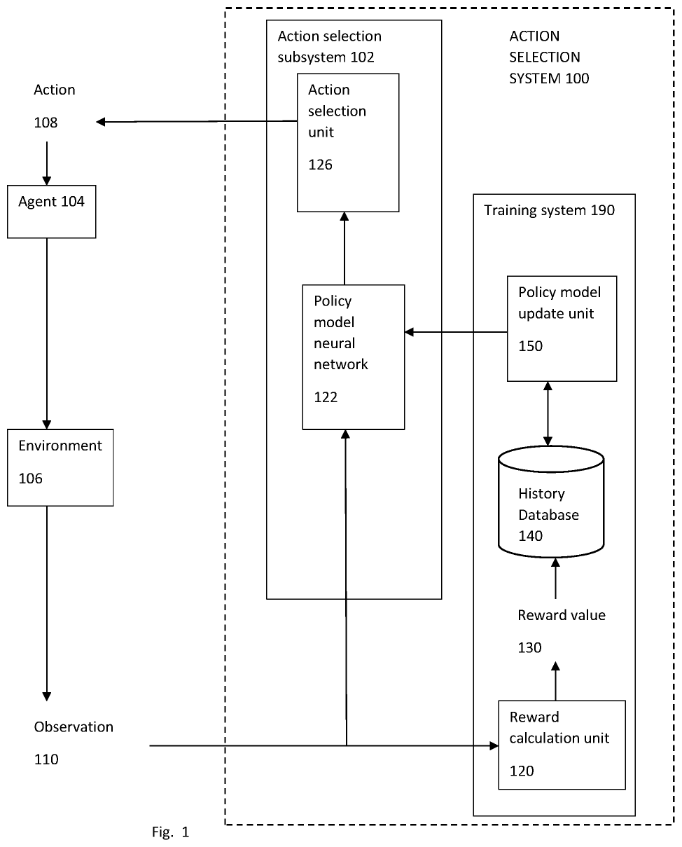

FIG. 1 shows an example action selection system 100. The action selection system 100 is an example of a system implemented as computer programs on one or more computers in one or more locations in which the systems, components, and techniques described below are implemented.

The action selection system 100 controls an agent 104 interacting with an environment 106 to accomplish a task by selecting actions 108 to be performed by the agent 104 at each of multiple time steps during an episode in which the task is performed.

As a general example, the task can include one or more of, e.g., navigating to a specified location in the environment, identifying a specific object in the environment, manipulating the specific object in a specified way, controlling items of equipment to satisfy criteria, distributing resources across devices, and so on.

More generally, the task is specified by received rewards, e.g., such that an episodic return is maximized when the task is successfully completed. Rewards and returns will be described in more detail below. Examples of agents, tasks, and environments are also provided below.

An “episode” of a task is a sequence of interactions during which the agent attempts to perform a single instance of the task starting from some starting state of the environment. In other words, each task episode begins with the environment being in an initial state, e.g., a fixed initial state or a randomly selected initial state, and ends when the agent has successfully completed the task or when some termination criterion is satisfied, e.g., the environment enters a state that has been designated as a terminal state or the agent performs a threshold number of actions without successfully completing the task.

At each time step during any given task episode, the system 100 receives an observation 110 characterizing the current state of the environment 106 at the time step and, in response, selects an action 108 to be performed by the agent 104 at the time step. An action to be performed by the agent will also be referred to in this specification as a “control input” generated by the action selection system 100. After the agent performs the action 108, the environment 106 transitions into a new state at the next time step.

To control the agent, at each time step in the episode, an action selection subsystem 102 of the system 100 may use a policy model neural network 122 and optionally an action selection unit 126 (e.g. a low-level controller neural network) to select the action 108 that will be performed by the agent 104 at the time step based on the output of the policy model neural network (the “policy output”). Thus, the action selection subsystem 102 uses the policy model neural network 122 to process the observation 110 to generate the policy output, and then the action selection unit 126 uses the policy output to select the action 108 to be performed by the agent 104 at the time step.

The function performed by the policy model neural network 122 is defined by a set of parameters ϕ which may comprise weights and/or bias values of neural units (nodes), each of which is located in one of one or more layers of the policy model neural network, and which generates an output as a function (e.g. a non-linear function) of a weighted sum of the inputs to the neural unit plus a bias value. The input to the policy model neural network 122 comprises the observation 110, and may further comprise an action a which the agent may take in response to the observation 110.

In one example, the policy output may uniquely identify an action (e.g. it may be a “one-hot” vector which has respective components for each possible action, and for which only one of the components is non-zero, indicating that the corresponding action should be taken. In this case, the action selection unit 126 may be omitted (i.e. the policy output may be transmitted, as control data specifying the action 108, to the agent 104), or the action selection unit 126 may merely translate the policy output into a control input (i.e. control data in a format the agent can recognize and implement) to cause the agent 104 to perform the identified action 108.

In another example, the policy output may include a respective numerical value for each action in a set of actions. For example, the policy output may include a respective Q-value for each action in the fixed set. This may be generated by successively providing inputs to the policy neural network 122 which are each the observation 110 and one of the actions in the set, and forming the policy output as the corresponding successive outputs (Q-values) of the policy neural network 122. A Q-value for an action is an estimate of a return that would result from the agent performing the action in response to the current observation and thereafter selecting future actions performed by the agent in accordance with current values of the parameters of the policy model neural network 122 and the action selection unit 126.

The action selection unit 126 may select the action 108, e.g., by selecting the action with the highest numerical value, or by treating the numerical values in the policy output as a defining a probability distribution over the set of actions, and sampling an action in accordance with the probability distribution. For example, if the numerical values are Q-values, the action selection unit 126 may process the Q-values (e.g., using a soft-max function) to generate a respective probability value for each action, which may be used to select the action, or may select the action with the highest Q-value.

As another example, when the action space is continuous, the policy output may include parameters of a probability distribution over the continuous action space and the action selection unit 126 can select the action by sampling from the probability distribution or by selecting the mean action. A continuous action space is one that contains an uncountable number of actions, i.e., where each action is represented as a vector having one or more dimensions and, for each dimension, the action vector can take any value that is within the range for the dimension and the only constraint is the precision of the numerical format used by the system 100.

As yet another example, when the action space is continuous the policy output may include a regressed action, i.e., a regressed vector representing an action from the continuous space, and the action selection unit 126 may select the regressed action as the action 108.

An observation of the environment at a certain time t during a certain episode is denoted by sₜ. For simplicity, it will be assumed in the following that the observation completely describes (“characterizes”) the state of the environment at that time, so that in some cases sₜ is described as the state of the environment at that time, but more generally the observation sₜ may not fully describe the state (e.g. it may only show part of the environment, or only show a view of the environment from one perspective).

The action 108 performed by the agent 104 at time t is denoted at. At each time step t (except an initial time step, which may be denoted t=0), the state of the environment 106 at the time step, as characterized by the observation 110 at the time step (i.e. se), depends on the state of the environment 106 at the previous time step t−1 and the action 108 performed by the agent 104 at the previous time step (i.e. aₜ₋₁).

The policy model neural network 122 is defined by a set of numerical parameters. A training system 190 within the system 100, or another training system, can train the policy model neural network 122 (i.e. iteratively vary the numerical parameters of the policy model neural network 122). This training may be performed in parallel with the selection of actions 108 by the action selection subsystem 102 (“online” training). Once the policy model neural network 122 has been trained, the training system 190 may be removed from the action selection system 100, e.g. discarded.

Generally, the training is based on a reward value 130 for each observation which is dependent on (i.e. derived using) the observation 110, and which is generated using the observation 110 by a reward calculation unit 120. The reward value (or more simply “reward”) for a given time t, dependent on sₜ, is a scalar numerical value denoted

$${r}_{t}^{total} ,$$

and characterizes the progress of the agent 104 towards completing the task. The training process is called “reinforcement learning”.

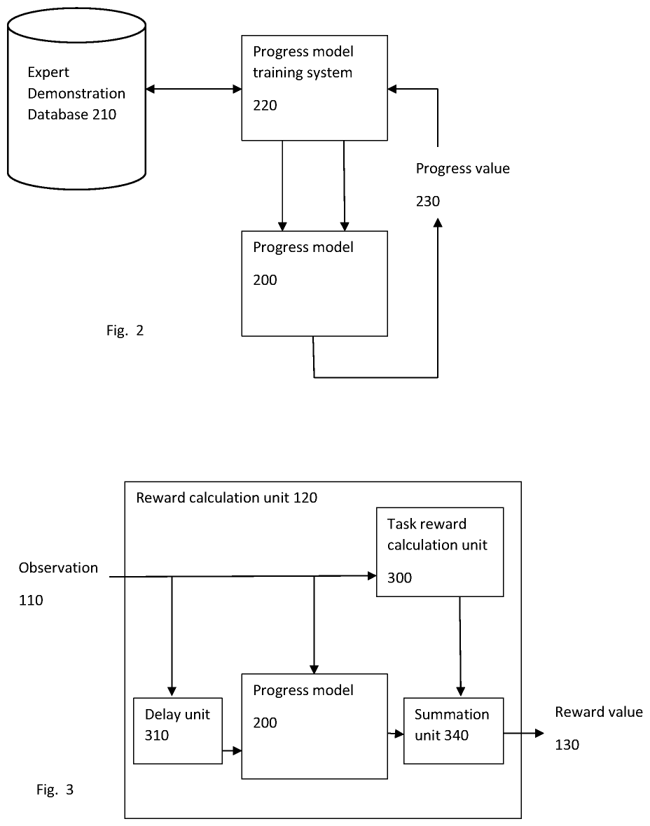

The reward value 130 is the value of a reward function of sₜ (and optionally of other data, as described below). The reward function may include multiple terms which are summed to produce the reward value 130. The generation of one term of the reward function (an “exploration reward term”) in example implementations of the present disclosure is described below with reference to FIGS. 2 and 3.

As another example, the reward function can include an “extrinsic” term which indicates whether the observation 110 indicates that the task has been solved (according to one or more criteria). For example, the extrinsic term may be a sparse binary reward that is zero unless the task is successfully completed as a result of the last action performed, i.e., is only non-zero, e.g., equal to one, if the task is successfully completed as a result of the last action performed.

As another example, the reward function can include an extrinsic reward term which is a dense reward that measures a progress of the agent towards completing the task as of individual observations received during the episode of attempting to perform the task, i.e., so that non-zero rewards can be and frequently are received before the task is successfully completed.

The structure and operation of the reward calculation unit 120 in an example implementation of the present disclosure is described below with reference to FIG. 3.

A policy model update unit 150 of the training system 190 trains (i.e. iteratively modifies) the policy model neural network 122 based on the reward values 130, e.g. such that, while performing any given task episode, the system 100 selects actions which tend to increase the rewards 130. Specifically, the policy model update unit 150 iteratively modifies the policy model neural network 122 in order to attempt to maximize a return that is received over the course of the task episode. That is, the policy model neural network 122 may be trained such that, at each time step during the episode, the action selection subsystem 102 selects actions that attempt to maximize the return that will be received for the remainder of the task episode starting from the time step. More generally, the policy model update unit 150 modifies the policy model neural network 122 such that the action selection subsystem 102, upon receiving an observation 110, selects an action 108 which is statistically associated with a high future return which is a (weighted) sum of the values of

$${r}_{t}^{total}$$

over multiple future time steps (i.e. the corresponding rewards for multiple future observations).

Generally, at any given time step, the return that will be received is a combination of the reward values 130 that will be received at time steps that are after the given time step in the episode.

For example, at a time step t, the return can satisfy:

$${\sum }_{i} {γ}^{i - t - 1} {r}_{i}^{total} ,$$

where i ranges either over all of the time steps after t in the episode or for some fixed number of time steps after t within the episode, γ is a discount factor that is greater than zero and less than or equal to one, and

$${r}_{i}^{total}$$

is the reward value 130 at time step i.

In implementations of the present disclosure, the policy model update unit 150 may use any known training algorithm to train the policy model neural network 122. Many such reinforcement learning algorithms are known. Some such algorithms employ a history database 140 which is composed of tuples drawn from episodes. The history database 140 may be populated during the learning procedure and/or store tuples obtained from another source (e.g. another instance of the action selection system 100 used to learn the same task). For example, a given tuple may be (sₜ, aₜ, sₜ+, rₜ₊₁). The tuples may be associated in ordered sequences, such that each sequence of tuples (a “trajectory”) describes multiple time-steps of (e.g. the whole of) a respective episode. Typically, during “online” learning the training occurs while the action selection subsystem 102 performs episodes, and new tuples drawn from these new episodes are added to the history database 140.

In some known reinforcement learning algorithms, the training system 190 also trains a value neural network (not shown) jointly with the policy model neural network 122. That is, while training through reinforcement learning, the training system 190 trains the value neural network and the policy model neural network 122. The value neural network is a neural network that, at any given time step, is configured to receive a value input characterizing the state of the environment at the time step (the “input state”, e.g. the observation 110) and process the value input to generate a value output that estimates a value of the input state of the environment to performing the task. The “value” of an input state is the return that will be achieved starting from the input state given that actions are selected using the policy model neural network 122 starting from the input state. In these implementations, the training system 190 can perform the training using an actor-critic reinforcement learning technique, e.g., Maximum a Posteriori Policy Optimization (MPO) or another appropriate technique.

As mentioned above, once the online learning is complete, the training selection system 190 may be removed (e.g. disabled or discarded), and the action selection subsystem 102 may be deployed to generate actions for further control of the agent 104 in new episodes. There may be no further training of the trained action selection subsystem 102 (e.g. no further updates to the policy model neural network 122).

We now turn to a description of the reward calculation unit 120 of FIG. 1. As noted above the reward value 130, denoted

$${r}_{t}^{total}$$

is dependent upon sₜ, the state of the environment at time step t of the episode. The present disclosure proposes that the reward includes at least one term which is an “exploration reward term” which is dependent also upon a previous time step (if any) of the same episode.

The reward value calculation unit 120 calculates the value of the exploration reward term using (or equal to) a progress value which is generated by a progress model, which comprises a trained neural network (“progress neural network”) which receives an input which is, or which is based on, an input to the progress model. The progress model is configured to generate an output (a “progress value”) based on the output of the progress neural network. Optionally, as described below, the progress model may include an output unit for processing the output of the progress neural network to generate the progress value. FIG. 2 shows the structure of a system within which the progress model, denoted 200 can be trained (i.e. by training the progress neural network).

The system of FIG. 2 includes an expert demonstration database 210 which includes multiple “expert demonstrations” [symbol] of performing the task, that is data describing a plurality of episodes in which one or more experts (e.g. human experts, but in principle the experts may comprise artificial expert(s) or even animal(s)) performed the task. Each expert demonstration comprises data which describes successive states of the environment while a corresponding one of the experts performed the task (e.g. by controlling an agent, such as an agent with the same form as the agent 104 of FIG. 1 to operate in the environment 106, or by controlling other tools in the environment). Each expert demonstration may, for example, be in the form of an ordered sequence of observations

$${s}_{t}^{d}$$

where t in this case denotes a time step of the expert demonstration d.

The system of FIG. 2 further includes a progress model training system 220. The progress model training system 220 successively selects one of the expert demonstrations, and selects a pair of observations from that expert demonstration. These observations of the environment, from different time steps i, j of the expert demonstration d, can be denoted

$${s}_{i}^{d} and {s}_{j}^{d} ,$$

where i and j are not equal (e.g. i may always be less than j).

The progress neural network of the progress model 200 is defined by a set of variable numerical parameters denoted θ. The progress model 200 is configured, upon receiving

$${s}_{i}^{d} and {s}_{j}^{d} ,$$

to output a progress value 230 denoted

$$f * ( {s}_{i}^{d} , {s}_{j}^{d} ; θ ) .$$

The program model training system 220 is configured to iteratively train the numerical parameters θ of the progress neural network such that the progress value

$$f * ( {s}_{i}^{d} , {s}_{j}^{d} ; θ )$$

is trained to be a value

$${y}_{i , j}^{d}$$

which is indicative of the difference between i and j.

In principle, the program model training system 220 could train the numerical parameters θ of the progress neural network, aiming to make it generate an output equal to |j−i|, which the progress model could then output as the progress value.

However, expert demonstrations by human experts can have very long episodes (e.g. if the observations are photographs of the environment taken at 50 frames per second, while a human expert takes 10 minutes to perform a task, there are 30,000 observations in the expert demonstration). Furthermore, human experts have different degrees of skill, and may perform the task in different ways, so that the number of observations in different expert demonstrations may be very different. For these reasons, it has been found preferable if the progress neural network of the progress model 200, defined by the parameters θ, is trained to output a progress value called a “progress estimate” which varies more slowly than linearly with |j−i|. For example, the progress model 200 may be configured to comprise a progress neural network having the numerical parameters θ and which is trained to generate a progress estimate f(,; θ) which varies more slowly than linearly with |j−i|. The progress model may further comprise an output unit which generates the progress value f* from the progress estimate f(,; θ).

For example, the progress model training system 210 may train the numerical parameters θ of the progress neural network, such that the progress estimate

$$f ( {s}_{i}^{d} , {s}_{j}^{d} ; θ )$$

is trained to be

$${y}_{i , j}^{d} = sgn ( j - i ) log ( 1 + \vert j - i \vert ) . \qquad ( 1 )$$

If the observations

$${s}_{i}^{d} and {s}_{j}^{d}$$

are always such that i is less than j, then Eqn. 1 is more simply

$${y}_{i , j}^{d} = log ( 1 + j - i ) .$$

The output unit of the process model 200 is configured to generate the reward value f* by transforming the progress estimate

$$f ( {s}_{i}^{d} , {s}_{j}^{d} ; θ )$$

back to linear space as

$$f * ( {s}_{i}^{d} , {s}_{j}^{d} ; θ ) = sgn ( f ( {s}_{i}^{d} , {s}_{j}^{d} ; θ ) ) * ( {e}^{f ( {s}_{i}^{d} , {s}_{j}^{d} ; θ )} + 1 ) . \qquad ( 2 )$$

The progress model 220 can train the progress neural network by minimizing the sum over batches of pairs of observations taken from the expert demonstration database 210 (where each pair of observations

$${s}_{i}^{d} , {s}_{j}^{d}$$

is taken from the same corresponding expert demonstration d), of the mean squared error between the true value

$${y}_{i , j}^{d} and f ( {s}_{i}^{d} , {s}_{j}^{d} ; θ ) .$$

In other words, the neural network of the progress model 200 is trained by minimizing the mean squared error between the true value

$${y}_{i , j}^{d}$$

in transformed space and

$$f ( {s}_{i}^{d} , {s}_{j}^{d} ; θ )$$

output by the progress neural network. The resulting progress model 200 captures a monotonically increasing function of progress within the expert trajectories.

Turning to FIG. 3, the structure of the reward calculation unit 120 of FIG. 1 is illustrated, incorporating the (e.g. trained) progress model 200. The reward calculation unit 120 receives an observation 110, e.g. denoted sₜ.

The reward calculation reward unit 120 may include a task reward calculation unit 300 which calculates an extrinsic reward term associated with a task in any (e.g. conventional) way (e.g. as described above, as a sparse binary reward that is zero unless the task is successfully completed as a result of the action being performed, or as a dense reward that measures a progress of the agent towards completing the task). The extrinsic reward term which the task reward calculation unit 200 generates based on observation sₜ may be denoted

$${r}_{t}^{c} .$$

The observation 110 is passed by the reward calculation unit 120 also to a delay unit 210 and in parallel to the progress model 200. The delay unit 310 outputs a state it receives with a delay of k steps, where k is a hyper-parameter (an integer which is at least one, and may be higher than one). Thus, the progress model 200 receives at time t the observation sₜ and the observation sₜ₋ₖ. Accordingly, the progress model outputs the progress value f*(sₜ₋ₖ, sₜ; θ). Note that in the case that t is less than k (e.g. in the case t=0), so that sₜ₋ₖ does not exist, the progress value output by the progress model 200 may be a default value, such as zero.

The progress value 230, that is f*(sₜ₋ₖ, sₜ; θ), may be understood as an estimate of the number of time steps which the ensemble of experts who produced the expert demonstrations in the expert demonstration database 210, would take to transform the environment from state sₜ₋ₖ to state sₜ. In other words, the progress value 230, is an estimate of how much progress has been made towards solving the task between times t−k and time t. Thus, the progress value 230 distills the knowledge of the expert trajectories, to provide an progress value 230 which is a component of the reward value 130. Note that this may be achieved without any knowledge of the actions which the experts performed during the expert demonstrations. Thus, even if the experts produced the expert demonstrations in a way which the agent 104 cannot possibly mimic (e.g. because the experts had access to tools which the agent 104 does not), the expert demonstrations provide an exploration reward term to improve the training of the action selection subsystem 102. In other words, the reward value provides a way of employing expert demonstrations in imitation learning, even in cases in which the actions performed by the experts are not recorded, or the expert(s) performed the task in a different way from the agent.

During the training of the policy model neural network 122, and in particular during an episode in which the action selection subsystem 102 controls the agent 104 at successive time steps to attempt to solve the task, at each time step t the reward calculation unit 120 computes the reward value 130, denoted by

$${r}_{t}^{total} ,$$

by using a summation unit 340 to produce a weighted sum of

$${r}_{t}^{c}$$

and f*(sₜ₋ₖ, sₜ; θ). In other words, the reward value 130 is a total reward:

$${r}_{t}^{total} = {r}_{t}^{c} + {ω}^{a} {f}^{*} ( {s}_{t - k ,} {s}_{t} ; θ ) , \qquad ( 3 )$$

where ω^{a} is a hyper-parameter greater than zero. The exploration reward term of the reward function is ω^{a}f*(sₜ₋ₖ, sₜ; θ).

The reward value 130 is used by the policy model update unit 150 for reinforcement learning in a conventional way, using any known reinforcement learning algorithm. For example, the training system 190 may generate the tuple (sₜ₋₁, aₜ₋₁, sₜ, rₜ^{total}) and transmit it to the history database 140 for access by the policy model update unit, and/or directly to the policy model update unit 150. If it is transmitted to the history database 140 it may be incorporated as one tuple of a trajectory describing the episode, i.e. linked to other tuples so that the values of sₜ, aₜ, and

$${r}_{t}^{total}$$

for each of the time steps t of the episode are stored in association, and available for the policy model update model 150 to use to update the policy model neural network, e.g. by training the policy model neural network 122 to increase the likelihood that the action selection subsystem 102 outputs an action 108 associated with a high return over future time steps. Updates to the policy model neural network may optionally be carried out by considering a trajectory as a whole.

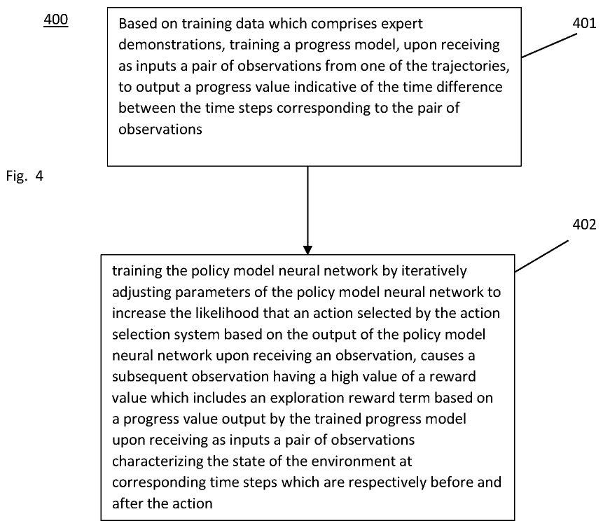

FIG. 4 illustrates shows a method 400 which is an example of the present disclosure as described above. The method 400 is an example of a method performed by computer programs on one or more computers in one or more locations in which the systems, components, and techniques described herein are implemented.

Step 401 is the offline process described above in relation to FIG. 2. Based on training data which comprises the expert demonstrations in the expert demonstration database 210, the progress neural network of the progress model 200 is trained, upon receiving as inputs a pair of observations

$${s}_{i}^{d} , {s}_{j}^{d}$$

from one of the trajectories d, such that the progress model 200 outputs a progress value f*(sₜ₋ₖ, sₜ; θ) indicative of the time difference |j−i| between the time steps i and j corresponding to the pair of observations. The progress value may linearly dependent on the time difference, but the output of the progress neural network may vary non-linearly with the time difference.

In step 402, the training system 190 trains the policy model neural network 122 by iteratively adjusting parameters of the policy model neural network 122 to increase the likelihood that an action selected by the action selection subsystem 102 based on the output of the policy model neural network 122 upon receiving an observation 110, causes at least one subsequent observation having a high value of a reward value 130. The reward value 130 is the value of a reward function which includes an exploration reward term based on a progress value output by the trained progress model 120 upon receiving as inputs a pair of observations characterizing the state of the environment at corresponding time steps which are respectively before and after the action.

In one example, step 402 is performed by the online process described above in relation to FIG. 3, referring to FIG. 1. In this case the reward value for the action aₜ₋₁ is

$${r}_{t}^{total} .$$

This is the value of a reward function (given in Eqn. (3) above) which includes an exploration reward term ω^{a}f*(sₜ₋ₖ, sₜ; θ) based on a progress value f*(sₜ₋ₖ, sₜ; θ) output by the trained progress model 200 upon receiving as inputs the pair of observations sₜ₋ₖ and sₜ which are respectively before and after the action aₜ₋₁.

An example of the method 400 can be written as the following pseudocode:

```
Input: Dataset [symbol]   , hyperparameters k and w^{a}
For epoch m = 1, 2, ... M do
  $Sample minibatch \{ {s}_{i}^{d} , {s}_{j}^{d} \} from 𝒟$
  Update the parameters of the progress model
  ${θ}_{m + 1} ← {θ}_{m} + α * {\sum }_{i , j , d} ∇ {( {y}_{i , j}^{d} - f ( {s}_{i}^{d} , {s}_{j}^{d} ; θ ) )}^{2}$
For epoch j = 1, 2, ... J do
  Sample a trajectory τ based on current state of the policy model neural
network
  For each time step of the trajectory τ
    $Compute the progress value {f}^{*} ( {s}_{t - k} , {s}_{t} ; θ ) and extrinsic reward {r}_{t}^{c}$
    $Compute total reward as {r}_{t}^{total} ← {r}_{t}^{c} + {ω}^{a} {f}^{*} ( {s}_{t - k} , {s}_{t} ; θ )$
  Update parameters ϕ of the policy model neural network the total
rewards over τ using using any known RL algorithm
```

Here α is a real parameter which is chosen to optimize the speed of convergence in step 401.

Either or both of steps 401 and 402 (and particularly step 401) may include an optional preliminary step (not shown) of filtering the observations which are used in the step to remove “extraneous” information which is indicative of the time step of the observation, but which is not indicative of progress in the task. For example, in the case that observations comprise images, each observation may include an image of a clock, such that the position of each observation within the corresponding trajectory is indicated by the time shown on the clock. In another example, the brightness of each image may be an indication of a time of day at which the image was captured, such that the position of each observation within the corresponding trajectory is indicated by the corresponding level of brightness. Neither of these pieces of information is per se indicative of progress in the task, so if the progress model 200 relies on this data, the progress value will be of little or no help in providing a total reward value 130 which is denser than the extrinsic reward value. The filtering may comprise removing a portion of the observation (e.g. a portion which shows the clock) or applying an equalization to the observations (e.g. to equalize average brightness between them), to eliminate the risk of the progress model 200 relying on the extraneous information.

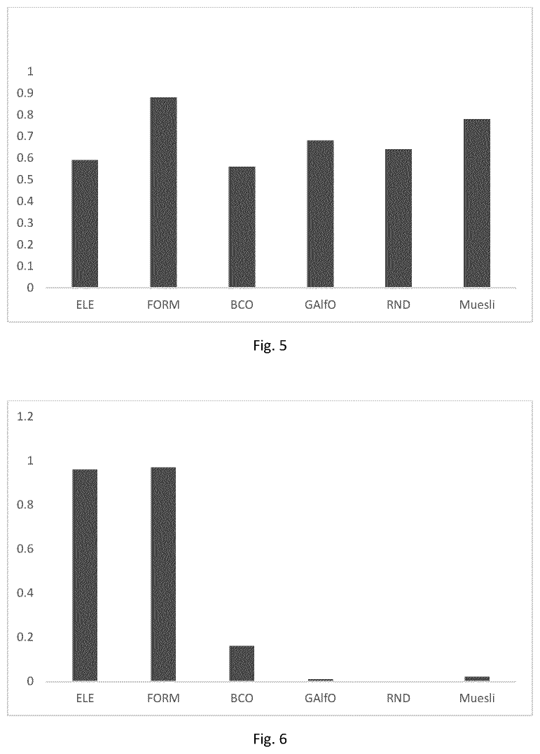

Turning to FIGS. 5, 6 and 7, experimental results are shown of using the example of the present disclosure explained with reference to FIGS. 1-4. The graph shows the total episode return achieved by six reinforcement learning (RL) algorithms (one example of the present techniques and five comparative examples which are known RL algorithms) for three tasks included in the NetHack video game. The observations for these tasks are images of a graphical user interface.

A dataset recording how human players have played the video game is available at http://nethack.alt.org. This dataset was used to produce the “expert demonstration database” in the experiments which were performed at a time when the dataset contained 7 million recorded games. The expert demonstration database was filtered so that it only contained episodes from the most skillful of the users, according to a metric available at the website.

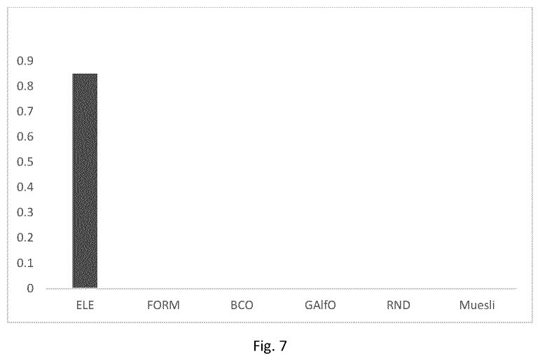

The three tasks used for the experiments were “Score” (FIG. 5), “Depth 2” (FIG. 6) and “Depth 4” (FIG. 7). The vertical axis shows the normalized episode return for the respective task for each of the six RL algorithms. For each of the six RL algorithms, the training was performed using 1 billion training steps, which is a standard frame budget established in the literature. Episodes were terminated after 1M environment steps (or when the environment reached a stage at which the episode was terminated automatically, e.g. the agent “died” in the game).

A first of the six reinforcement learning algorithms is the example of the present disclosure described above with reference to FIGS. 1-4, which is referred to in FIGS. 5-7 as “ELE” (explore like experts). The architecture of the policy model neural network was composed of a feed forward ResNet (residual neural network) torso without normalization layers, followed by an LSTM (long short term memory) and a residual connection from the torso. The hyperparameter w^{a} was chosen to be equal to 0.01. Various choices were tried for the hyperparameter k, as powers of two from 2 to 128. The results did not depend strongly upon the choice, but the value k=8 was found to be a good choice and used to produce the results of FIGS. 5-7. The observations in the expert trajectories were filtered prior to performing step 401 to remove a portion of the image showing a timer. The corresponding portion of the observations 110 was removed in performing step 402 before inputting each observation to the training system 190. The known reinforcement learning algorithm employed by the policy model update unit 150 was the Muesli algorithm (M. Hessel, et al., “Muesli: Combining improvements in policy optimization”, in International Conference on Machine Learning, 2021).

The five other algorithms used for comparison were FORM (an action-free limitation learning approach described at A. Jaegle, et al., “Imitation by predicting observations”, in International Conference on Machine Learning, 2021), BCO (F. Torabi, et al., “Behavioral cloning from observation”, arXiv:1805.01954, 2018a.), GAIfO (F. Torabi, et al., “Generative adversarial imitation from observation”, abs/1807.06158), RND (Y. Burda, et al., “Exploration by random network distillation”, in 7th International Conference on Learning Representations, 2019) and the original version of Muesli.

It will be seen that for the task “Score” (FIG. 5), which has a dense extrinsic reward value, ELE performed about as well as the other RL techniques, though FORM performed slightly better. Due to the dense extrinsic reward function, the progress value did not provide much additional value.

In the tasks “Depth 2” (FIG. 6) and “Depth 4” (FIG. 7), the objective is to reach a dungeon level which is respectively 2 or 4 levels below a surface level, finding stairs at each level. The extrinsic reward value is sparse for these tasks, particularly for “Depth 4”. For “Depth 2”, ELE and FORM performed equally well (within the error bars of the experiment) while the other algorithms failed. For “Depth 4”, FORM failed also, and ELE was the only one of the six RL algorithms which was capable of learning this task successfully. Furthermore, its performance compared favorably to the expert demonstrations used in step 401.

Various variations of the example described above with reference to FIGS. 1-4 are now presented. Except where otherwise stated, the features of these variants explained below may be used in combination with, or in the absence of, the optional features explained above with reference to FIGS. 1-4, and in combination with each other. All the variants may be trained in other examples of the method 400 of FIG. 400.

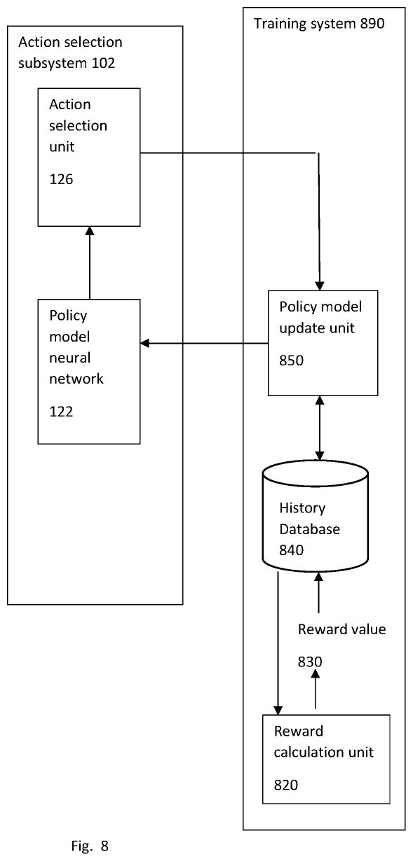

FIG. 8 illustrates a first variant of the example of FIG. 1 in which action selection subsystem 102 has the same structure as in FIG. 1; that is, it includes a policy model neural network 122 and an optional action selection unit 126, which may have the same form as the corresponding units of FIG. 1. However, in the case of FIG. 8 the action selection subsystem 102 is trained using a training system 890 having a policy model update unit 850 which is adapted to perform “offline learning”, rather than “online learning” as in FIG. 1. That is, during the training procedure the policy model neural network 112 of the action selection subsystem 102 is trained based on trajectories stored in a history database (shown as history database 840), but the action selection system is not used during the training to control an agent, and new trajectories are not added to the history database 840. Many algorithms are known for offline learning, and any of these may be used by the training system 890.

The history database 840 may have been received from elsewhere (e.g. records of training other agents) and may record trajectories of episodes in which an agent (of the type which the action selection subsystem 102 is being trained to control) was controlled to perform the task. The history database 840 may be received in a format in which each trajectory is stored as a plurality of associated tuples

$$( {s}_{t - 1} , {a}_{t - 1} , {s}_{t} , {r}_{t}^{c} )$$

where

$${r}_{t}^{c}$$

is an extrinsic reward of a known type.

Prior to training the action selection subsystem 102, a reward calculation unit 820 may be applied to these tuples, to replace each tuple

$$( {s}_{t - 1} , {a}_{t - 1} , {s}_{t} , {r}_{t}^{c} )$$

with a corresponding modified tuple

$$( {s}_{t - 1} , {a}_{t - 1} , {s}_{t} , {r}_{t}^{total} ) .$$

### Here

$${r}_{t}^{total}$$

is as given b En. (3). That is, the reward calculation unit 820 modifies each tuple by replacing

$${r}_{t}^{c}$$

with a reward value 830. The reward value 830 is the sum of the extrinsic reward term

$${r}_{t}^{c}$$

and an exploration reward term ω^{a}f*(sₜ₋ₖ, sₜ; θ) based on a progress value f*(sₜ₋ₖ, sₜ; θ). The progress value may be the output of a trained progress model of the reward calculation unit 820, upon receiving as inputs a pair of observations sₜ₋ₖ and sₜ from the corresponding trajectory which are respectively before and after the action aₜ₋₁.

The trained progress model may be the progress model 200 which was trained as explained above with reference to FIG. 2. In other words, the progress value f*(sₜ₋ₖ, sₜ; θ) is an estimate of the number of time steps which the ensemble of experts who produced the expert demonstrations stored in the database 210 of FIG. 2 would have taken to transform the environment from a state represented by the observation sₜ₋ₖ, to a state represented by the observation sₜ. In the case of an observation in the history database for which t is less than k, so that the progress value is not defined, no modification may be made to

$${r}_{t}^{c} .$$

After the tuples in the history database 840 have been modified in this way, the policy model update unit 850 applies the known offline RL learning algorithm to train the policy model neural network 122 based on the modified tuples in the history database 840. Specifically, the policy model neural network 122 may be trained by the policy model update unit 850, such that upon the action selection subsystem 102 receiving an observation sₜ from one of the tuples in the history database 840, the action selection system 202 generates an action aₜ which the data in the history database 840 indicates is statistically associated with a high future return (i.e. a weighted sum of the values of

$${r}_{t}^{total}$$

over multiple future time steps (i.e. the corresponding total reward values for multiple future observations)).

Once the action selection subsystem 102 has been trained it may be deployed in the same way as the trained action selection subsystem described above with reference to FIG. 1. That is, it may be used in a system as shown in FIG. 1 but omitting the training system 190.

In a second variation of the example described above with reference to FIGS. 1-4, the reward calculation unit 120 of FIG. 3 may be replaced with a reward calculation unit for which the pair of observations which are input to the progress model 200 are not a pair of observations which are a fixed number of time steps apart (i.e. like the pair of observations sₜ₋ₖ, sₜ which are k time steps apart). Instead, the pair of observations may, for example, be s₀ and sₜ. That is, the observation which characterizes the state of the environment at a time step before the action aₜ₋₁ may be an observation so which characterizes the state of the environment at the start of the episode.

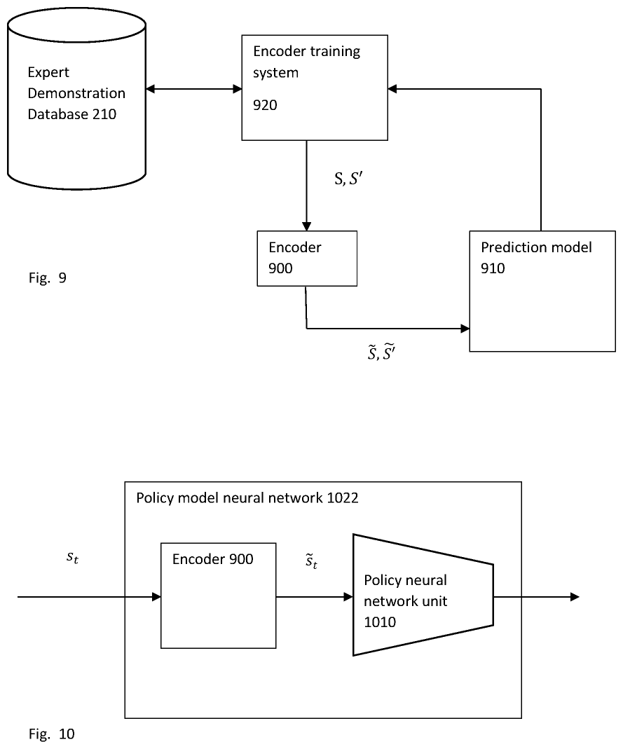

A third variant of the example of FIGS. 1-4, is explained with reference to FIGS. 9-11. This variant makes use of an encoder neural network (“encoder”) 900. The encoder 900 may take any conventional neural network form. For example, it could be a feed forward network (e.g. comprising a sequence of layers, including a plurality of nodes in each layer, with outputs of each layer (except the first layer of the sequence) being inputs to the next layer), and it may comprise one or more convolutional layers, particularly in the case that the observations are in the form of still or moving images as described below.

The input to the encoder 900 is a dataset having the size of one of the observations. The output of the encoder 900 has a smaller data size than the input (e.g. as measured by the number of bits respectively in the input and output). The function of the encoder 900 is to generate an encoded representation of an observation (e.g. a filtered observation) it receives, having a smaller data size than the observation itself. The encoder neural network 900 (like the policy model neural network and progress neural network) is defined by a plurality of variable numerical parameters, which can be denoted ψ.

In a preliminary step, the parameters ψ are trained within the system shown in FIG. 9. The system of FIG. 9 employs an expert demonstration database which may be the expert demonstration database 210 of the system shown in FIG. 2. It further includes an encoder training system 920 which is configured to select two observations from the expert demonstration database 210. The two observations may be observations from the same trajectory (i.e. expert demonstration episode) or from different respective trajectories. They are denoted S and S′.

The two observations Sand S′ are transmitted to the encoder 900 successively, and each is used separately by the encoder 900 to generate successively respective encoded representations denoted \tilde{S} and \tilde{S}′. The encoded representations \tilde{S} and \tilde{S}′ are input to a prediction model 910 which generates an output which is returned to the encoder training system 920. The prediction model 910 too is a neural network defined by a plurality of numerical parameters which can be varied by the encoder training system 920. The output of the prediction model 910 may have a binary value.

During an encoder training process, the encoder training system 920 performs an iterative process in which, at each iteration, a modification is made to the encoder 900 and/or the prediction model 910 to increase the value of an encoder reward function. The encoder reward function is the sum over a plurality of choices for the pair of observations S and S′, of a variable which, for each pair of observations, indicates whether the output of the prediction model correctly indicates whether the pair of observations S and S′ meet a similarity criterion. For example, the similarity criterion may be that the two observations S and S′ were derived from the same expert trajectory, and optionally also that the time difference between their respective time steps meets a proximity criterion. For example, the proximity criterion may be that the time difference is within a certain predefined range (e.g. no greater than a certain upper limit).

During the training, the encoder 900 and the prediction model 910 are trained jointly (i.e. updates to the encoder 900 and prediction model 910 are performed substantially simultaneously or interleaved). For the prediction model 910 to become successful at the task, the encoder 900 learns to encode representations in such a way that information helpful to the prediction model 910 is preserved, i.e. the information in the observations which is helpful to distinguish between the expert trajectories and to determine if the proximity criterion has been met.

Once the proximity model has been trained, it may be used as a component of the policy model neural network 122 and/or the progress model 200 of the system of FIG. 1.

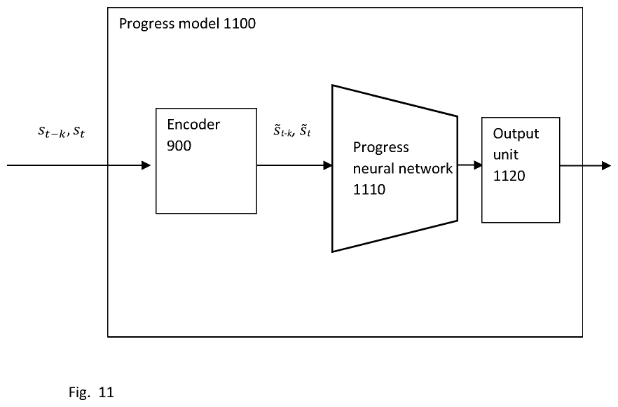

Specific possible forms of these two neural network systems incorporating the trained encoder 900 are shown respectively in FIGS. 10 and 11, as the policy model neural network 1022 and the policy model 1100. The use of these neural network is a further example of the method 400 of FIG. 4. The progress model 1100 is used, in steps 401 and 402 of method 400, to replace the progress model 200 in a system which is otherwise as shown by FIGS. 1-3. The policy model neural network 1022 is used, in step 402 of method 400, to replace the policy model neural network 122 in a system which is otherwise as shown by FIG. 1.

As shown in FIG. 10, the policy model neural network 1022 may comprise an instance of the encoder 900 which receives an observation 110, denoted sₜ, input to the policy model neural network 1022, and may generate an encoded representation \tilde{s}ₜ of the observation 110. The encoded representation is used as an input to a policy neural network unit 1010. The output of the policy neural network unit 1010 is the policy output of the policy model neural network 1022. The training of the policy model neural network 1022 in step 402 is performed by iteratively modifying the policy neural network unit 1010. In this process, the encoder 900 is typically not modified. Because of the existence of the encoder 900, the input data to the policy neural network unit 1010 (i.e. the encoded representation of observations 110) has a reduced size compared to the observations 110, with some irrelevant information removed, so that the policy neural network 1010 can be a simpler neural network (e.g. defined by fewer numerical parameters) than if the encoder 900 were not present, as in the policy neural network 122 of FIG. 1, and the training is easier and/or more accurate.

As shown in FIG. 11, the progress model 1100 may comprise an instance of the encoder 900 which receives successively two observations, and from them generates corresponding encoded representations. From the two encoded observations, a progress model neural network 1110 may successively generate a progress estimate. As in the case progress model 200 of FIGS. 1-3, the progress estimate may be received and modified by an output unit 1120 of the progress model 1100, to generate a progress value which is output by the progress model 1100. The two observations input to the progress model 1100 during the step 401 are the observations

$${s}_{i}^{d} and {s}_{j}^{d} .$$

The two observations input to the progress model 1100 during step 402 are sₜ₋ₖ and sₜ, and this case is shown in FIG. 11, where the corresponding encoded representations are denoted \tilde{s}ₜ₋ₖ and \tilde{s}ₜ. The training of the progress model 1100 in step 401 is performed by iteratively modifying the progress neural network 1110. In this process, the encoder 900 is typically not modified. Because of the existence of the encoder 900, the input data to the progress neural network 1110 (i.e. the encoded representation of observations sₜ₋ₖ and sₜ in the case of step 402) has a reduced size, with some irrelevant information removed, so that training the progress neural network 1110 is made easier and more accurate.

It has been found that using encoder(s) 900 in the policy model neural network 1022 and/or the progress model 1100, results in more rapid learning of the policy model neural network 1022 once the training of the policy model neural network 1022 in step 402 begins. Optionally, the same encoder 900 may be shared by the policy model neural network 1022 and the progress model 1100, or each may be provided with a different encoder, e.g. generated during two different instances of generating an encoder 900 using the system of FIG. 9.

There now follows a more detailed discussion of the environments and agents to which the disclosed methods can be applied.

In implementations the observation relates to a real-world environment and the selected action relates to an action to be performed by a mechanical agent. For example the training could be performed in a real-world environment or in a simulation of a real-world environment. The method may then use the trained or partially trained action selection neural network in the real-world e.g. to control a mechanical agent to perform the task while interacting with a real-world environment by obtaining the observations from one or more sensors sensing the real-world environment and using the policy output to select actions to control the mechanical agent to perform the task.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

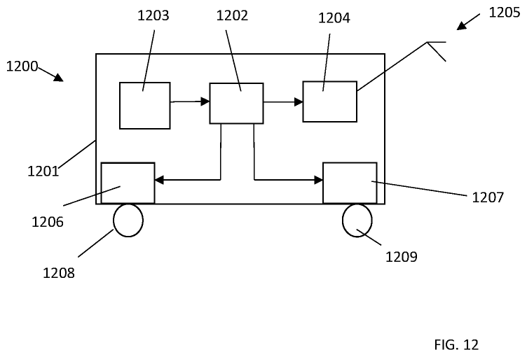

As an example, FIG. 12 shows a robot 1200 having a housing 1201. The robot includes, e.g. within the housing 1201 (or, in a variation, outside the robot 1200 but connected to it over a communications network), a control system 1202 which comprises an action selection system defined by a plurality of model parameters for each of one or more tasks which the robot is configured to perform. The control system 1202 may comprise the action selection subsystem 102 of FIG. 1. The control system 1202 has access for a corresponding database of model parameters for each given task, which may have been obtained for that task by the method of FIG. 4. The robot 1200 further includes one or more sensors 1203 which may comprise one or more (still or video) cameras. The sensors 1203 capture observations (e.g. images) of an environment of the robot 1200, such as room in which the robot 1200 is located (e.g. a room of an apartment). The robot may also comprise a user interface (not shown) such as microphone for receiving user commands to define a task which the robot is to perform. Based on the task, the control system 1202 may read the corresponding model parameters and configure the action selection subsystem 102 based on those model parameters. Note that, in a variation, the input from the user interface may be considered as part of the observations. There is only a single task in this case, and processing the user input is one aspect of that task.

Based on the observations captured by the sensors 1203, control system 1202 generates control data for an actuator 1204 which controls at least one manipulation tool 1205 of the robot, and control data for controlling drive system(s) 1206, 1207 which e.g. turn wheels 1208, 1209 of the robot, causing the robot 1200 to move through the environment according to the control data. Thus, the control system 1202 can control the manipulation tool(s) 1205 and the movement of the robot 1200 within the environment. In some implementations the environment is a real-world manufacturing environment for manufacturing a product, such as a chemical, biological, or mechanical product, or a food product. As used herein a “manufacturing” a product also includes refining a starting material to create a product, or treating a starting material e.g. to remove pollutants, to generate a cleaned or recycled product. The manufacturing plant may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

In some implementations, the agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control use of a resource the metric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment such as a heater, a cooler, a humidifier, or other hardware that modifies a property of air in the real-world environment. The task may comprise a task to control, e.g. minimize, use of a resource, such as a task to control electrical power consumption, or water consumption. The agent may comprise an electronic agent configured to control operation of the items of equipment, or to control operation of the ancillary, e.g. environmental, control equipment.

In general the actions may be any actions that have an effect on the observed state of the environment, e.g. actions configured to adjust any of the sensed parameters described below. These may include actions to control, or to impose operating conditions on, the items of equipment or the ancillary control equipment, e.g. actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g. minimize, use of a resource, such as a task to control use of electrical power or water, the metric may comprise any metric of use of the resource.

In some implementations the environment is the real-world environment of a power generation facility e.g. a renewable power generation facility such as a solar farm or wind farm. The task may comprise a control task to control power generated by the facility, e.g. to control the delivery of electrical power to a power distribution grid, e.g. to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such observations may thus include observations of wind levels or solar irradiance, or of local time, date, or season. Such sensors may include sensors configured to sense electrical conditions of the equipment such as current, voltage, power or energy; temperature or cooling of the physical environment; fluid flow; or a physical configuration of the equipment; and observations of an electrical condition of the grid e.g. from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmaceutically active compound pharmaceutically active compound and the agent is a computer system for determining elements of the pharmaceutically active compound and/or a synthetic pathway for the pharmaceutically active compound. The drug/synthesis may be designed based on a reward derived from a target for the pharmaceutically active compound, for example in simulation. As another example, the agent may be a mechanical agent that performs or controls synthesis of the pharmaceutically active compound.

In some applications the agent may be a software agent i.e. a computer program, configured to perform a task. For example the environment may be a circuit or an integrated circuit design or routing environment and the agent may be configured to perform a design or routing task for routing interconnection lines of a circuit or of an integrated circuit e.g. an ASIC. The reward(s) may then be dependent on one or more routing metrics such as interconnect length, resistance, capacitance, impedance, loss, speed or propagation delay; and/or physical line parameters such as width, thickness or geometry, and design rules. The reward(s) may also or instead include one or more reward(s) relating to a global property of the routed circuitry e.g. component density, operating speed, power consumption, material usage, a cooling requirement, level of electromagnetic emissions, and so forth. The observations may be e.g. observations of component positions and interconnections; the actions may comprise component placing actions e.g. to define a component position or orientation and/or interconnect routing actions e.g. interconnect selection and/or placement actions. The task may be, e.g., to optimize circuit operation to reduce electrical losses, local or external interference, or heat generation, or to increase operating speed, or to minimize or optimize usage of available circuit area. The method may include making the circuit or integrated circuit to the design, or with interconnection lines routed as determined by the method.

In some applications the agent is a software agent and the environment is a real-world computing environment. In one example the agent manages distribution of tasks across computing resources e.g. on a mobile device and/or in a data center. In these applications, the observations may include observations of computing resources such as compute and/or memory capacity, or Internet-accessible resources; and the actions may include assigning tasks to particular computing resources. The reward(s) may be configured to maximize or minimize one or more of: utilization of computing resources, electrical power, bandwidth, and computation speed.

In another example the software agent manages the processing, e.g. by one or more real-world servers, of a queue of continuously arriving jobs. The observations may comprise observations of the times of departures of successive jobs, or the time intervals between the departures of successive jobs, or the time a server takes to process each job, e.g. the start and end of a range of times, or the arrival times, or time intervals between the arrivals, of successive jobs, or data characterizing the type of job(s). The actions may comprise actions that allocate particular jobs to particular computing resources; the reward(s) may be configured to minimize an overall queueing or processing time or the queueing or processing time for one or more individual jobs, or in general to optimize any metric based on the observations.

As another example the environment may comprise a real-world computer system or network, the observations may comprise any observations characterizing operation of the computer system or network, the actions performed by the software agent may comprise actions to control the operation e.g. to limit or correct abnormal or undesired operation e.g. because of the presence of a virus or other security breach, and the reward(s) may comprise any metric(s) that characterizing desired operation of the computer system or network.

In some applications, the environment is a real-world computing environment and the software agent manages distribution of tasks/jobs across computing resources e.g. on a mobile device and/or in a data center. In these implementations, the observations may comprise observations that relate to the operation of the computing resources in processing the tasks/jobs, the actions may include assigning tasks/jobs to particular computing resources, and the reward(s) may relate to one or more metrics of processing the tasks/jobs using the computing resources, e.g. metrics of usage of computational resources, bandwidth, or electrical power, or metrics of processing time, or numerical accuracy, or one or more metrics that relate to a desired load balancing between the computing resources.

In some applications the environment is a data packet communications network environment, and the agent is part of a router to route packets of data over the communications network. The actions may comprise data packet routing actions and the observations may comprise e.g. observations of a routing table which includes routing metrics such as a metric of routing path length, bandwidth, load, hop count, path cost, delay, maximum transmission unit (MTU), and reliability. The reward(s) may be defined in relation to one or more of the routing metrics i.e. configured to maximize one or more of the routing metrics.

In some other applications the environment is an Internet or mobile communications environment and the agent is a software agent which manages a personalized recommendation for a user. The observations may comprise previous actions taken by the user, e.g. features characterizing these; the actions may include actions recommending items such as content items to a user. The reward(s) may be configured to maximize one or more of: an estimated likelihood that the user will respond favorably to being recommended the (content) item, a suitability unsuitability of one or more recommended items, a cost of the recommended item(s), and a number of recommendations received by the user, optionally within a time span.

As a further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g. an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e. observations of a mechanical shape or of an electrical, mechanical, or electro-mechanical configuration of the entity, or observations of parameters or properties of the entity. The actions may comprise actions that modify the entity e.g. that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g. in the form of computer executable instructions for manufacturing the entity. The process may include making the entity according to the design. Thus the design of an entity may be optimized, e.g. by reinforcement learning, and then the optimized design output for manufacturing the entity, e.g. as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

In some implementations the agent may not include a human being (e.g. it is a robot). Conversely, in some implementations the agent comprises a human user of a digital assistant such as a smart speaker, smart display, or other device. Then the information defining the task can be obtained from the digital assistant, and the digital assistant can be used to instruct the user based on the task.

For example, the reinforcement learning system may output to the human user, via the digital assistant, instructions for actions for the user to perform at each of a plurality of time steps. The instructions may for example be generated in the form of natural language (transmitted as sound and/or text on a screen) based on actions chosen by the reinforcement learning system. The reinforcement learning system chooses the actions such that they contribute to performing a task. A monitoring system (e.g. a video camera system) may be provided for monitoring the action (if any) which the user actually performs at each time step, in case (e.g. due to human error) it is different from the action which the reinforcement learning system instructed the user to perform. Using the monitoring system the reinforcement learning system can determine whether the task has been completed. During an on-policy training phase and/or another phase in which the history database is being generated, the experience tuples may record the action which the user actually performed based on the instruction, rather than the one which the reinforcement learning system instructed the user to perform. The reward value of each experience tuple may be generated, for example, by comparing the action the user took with a corpus of data showing a human expert performing the task, e.g. using techniques known from imitation learning. Note that if the user performs actions incorrectly (i.e. performs a different action from the one the reinforcement learning system instructs the user to perform) this adds one more source of noise to sources of noise which may already exist in the environment. During the training process the reinforcement learning system may identify actions which the user performs incorrectly with more than a certain probability. If so, when the reinforcement learning system instructs the user to perform such an identified action, the reinforcement learning system may warn the user to be careful. Alternatively or additionally, the reinforcement learning system may learn not to instruct the user to perform the identified actions, i.e. ones which the user is likely to perform incorrectly.

More generally, the digital assistant instructing the user may comprise receiving, at the digital assistant, a request from the user for assistance and determining, in response to the request, a series of tasks for the user to perform, e.g. steps or sub-tasks of an overall task. Then for one or more tasks of the series of tasks, e.g. for each task, e.g. until a final task of the series the digital assistant can be used to output to the user an indication of the task, e.g. step or sub-task, to be performed. This may be done using natural language, e.g. on a display and/or using a speech synthesis subsystem of the digital assistant. Visual, e.g. video, and/or audio observations of the user performing the task may be captured, e.g. using the digital assistant. A system as described above may then be used to determine whether the user has successfully achieved the task e.g. step or sub-task, i.e. from the answer as previously described. If there are further tasks to be completed the digital assistant may then, in response, progress to the next task (if any) of the series of tasks, e.g. by outputting an indication of the next task to be performed. In this way the user may be led step-by-step through a series of tasks to perform an overall task. During the training of the neural network, training rewards may be generated e.g. from video data representing examples of the overall task (if corpuses of such data are available) or from a simulation of the overall task.

As an illustrative example a user may be interacting with a digital assistant and ask for help performing an overall task consisting of multiple steps, e.g. cooking a pasta dish. While the user performs the task, the digital assistant receives audio and/or video inputs representative of the user's progress on the task, e.g. images or video or sound clips of the user cooking. The digital assistant uses a system as described above, in particular by providing it with the captured audio and/or video and a question that asks whether the user has completed a particular step, e.g. ‘Has the user finished chopping the peppers?’, to determine whether the user has successfully completed the step. If the answer confirms that the use has successfully completed the step then the digital assistant progresses to telling the user to perform the next step or, if at the end of the task, or if the overall task is a single-step task, then the digital assistant may indicate this to the user. The digital assistant may then stop receiving or processing audio and/or video inputs to ensure privacy and/or reduce power use.

In a further aspect there is provided a digital assistant device including a system as described above. The digital assistant can also include a user interface to enable a user to request assistance and to output information. In implementations this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g. a conversation agent such as LaMDA, Sparrow, or Chinchilla. The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks e.g. of a series of tasks, e.g. until a final task of the series. More particularly the assistance control subsystem and output to the user an indication of the task to be performed, capture, using the observation capture subsystem, visual or audio observations of the user performing the task, determine from the above-described answer whether the user has successfully achieved the task. In response the digital assistant can progress to a next task of the series of tasks and/or control the digital assistant, e.g. to stop capturing observations.

In the implementations above, the environment may not include a human being or animal. In other implementations, however, it may comprise a human being or animal. For example, the agent may be an autonomous vehicle in an environment which is a location (e.g. a geographical location) where there are human beings (e.g. pedestrians or drivers/passengers of other vehicles) and/or animals, and the autonomous vehicle itself may optionally contain human beings. The environment may also be at least one room (e.g. in a habitation) containing one or more people. The human being or animal may be an element of the environment which is involved in the task, e.g. modified by the task (indeed, the environment may substantially consist of the human being or animal). For example the environment may be a medical or veterinary environment containing at least one human or animal subject, and the task may relate to performing a medical (e.g. surgical) procedure on the subject. In a further implementation, the environment may comprise a human user who interacts with an agent which is in the form of an item of user equipment, e.g. a digital assistant. The item of user equipment provides a user interface between the user and a computer system (the same computer system(s) which implement the reinforcement learning system, or a different computer system). The user interface may allow the user to enter data into and/or receive data from the computer system, and the agent is controlled by the action selection policy to perform an information transfer task in relation to the user, such as providing information about a topic to the user and/or allowing the user to specify a component of a task which the computer system is to perform. For example, the information transfer task may be to teach the user a skill, such as how to speak a language or how to navigate around a geographical location; or the task may be to allow the user to define a three-dimensional shape to the computer system, e.g. so that the computer system can control an additive manufacturing (3D printing) system to produce an object having the shape. Actions may comprise outputting information to the user (e.g. in a certain format, at a certain rate, etc.) and/or configuring the interface to receive input from the user. For example, an action may comprise setting a problem for a user to perform relating to the skill (e.g. asking the user to choose between multiple options for correct usage of the language, or asking the user to speak a passage of the language out loud), and/or receiving input from the user (e.g. registering selection of one of the options, or using a microphone to record the spoken passage of the language). Rewards may be generated based upon a measure of how well the task is performed. For example, this may be done by measuring how well the user learns the topic, e.g. performs instances of the skill (e.g. as measured by an automatic skill evaluation unit of the computer system). In this way, a personalized teaching system may be provided, tailored to the aptitudes and current knowledge of the user. In another example, when the information transfer task is to specify a component of a task which the computer system is to perform, the action may comprise presenting a (visual, haptic or audio) user interface to the user which permits the user to specify an element of the component of the task, and receiving user input using the user interface. The rewards may be generated based on a measure of how well and/or easily the user can specify the component of the task for the computer system to perform, e.g. how fully or well the three-dimensional object is specified. This may be determined automatically, or a reward may be specified by the user, e.g. a subjective measure of the user experience. In this way, a personalized system may be provided for the user to control the computer system, again tailored to the aptitudes and current knowledge of the user.

Optionally, in any of the above implementations, the observation at any given time step may include data from a previous time step that may be beneficial in characterizing the environment, e.g., the action performed at the previous time step, the reward received at the previous time step, or both.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows can be performed by and apparatus can also be implemented as a graphics processing unit (GPU).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method of training a policy model neural network of an action selection system configured to generate control data for controlling an agent interacting with an environment to perform a task, the policy model neural network being configured to receive input data comprising an observation characterizing the state of the environment and, based on the observation, to generate an output, the action selection system being configured to select an action for the agent to perform based on the output of the policy model neural network;
the method employing:
a database of training data which comprises a plurality of trajectories, each trajectory comprising a sequence of observations characterizing consecutive states of the environment at corresponding time steps during a performance of the task, and
a progress model configured to generate an output upon receiving two observations as inputs;
the method comprising:
based on the training data, training the progress model, upon receiving as inputs a pair of observations from one of the trajectories, to output a progress value indicative of the time difference between the time steps corresponding to the pair of observations; and
training the policy model neural network by iteratively adjusting parameters of the policy model neural network to increase the likelihood that an action selected by the action selection system based on the output of the policy model neural network upon receiving an observation, causes a subsequent observation having a high value of a reward value;
the reward value being the value of a reward function which includes an exploration reward term based on a progress value output by the trained progress model upon receiving as inputs a pair of observations characterizing the state of the environment at corresponding time steps which are respectively before and after the performance of the action.

2. The method according to claim 1 in which, for each action, the reward function additionally includes a reward term which is generated by comparing an observation of the state of the environment following the action to one or more criteria defining the task.

3. The method according to claim 1 in which the progress value indicative of the time difference is proportional to a logarithmic function of the time difference.

4. The method according to claim 3 in which the exploration reward term is an exponential function of the output of the progress model upon receiving the pair of observations.

5. The method according to claim 1 in which comprises a step of filtering observations in the training data, prior to generating the progress model, to remove a part of each observation which is indicative of the corresponding time step.

6. The method of claim 1 in which, in the training of the policy model neural network, the pair of observations characterize the state of the environment respectively at a first time step which is before the performance of the action and a second time step which is after the performance of the action, and the first time step is a predetermined number of time steps before the second time step.

7. The method according to claim 1 in which the policy model neural network defines, for an observed state of an environment, a state-action distribution over a set of possible actions to be performed by an agent interacting with the environment to perform a task.

8. The method according to claim 1 in which the training of the policy model neural network is performed by a training process comprising, at successive time steps,
selecting corresponding actions for the agent to perform using the policy model neural network, and adjusting parameters of the policy model neural network based on reward values associated with the actions selected using the output of the policy model neural network.

9. The method according to claim 8 in which, during the training process, the agent is controlled to perform one or more sequences of successive actions selected by the action selection system based on sequences of corresponding successive observations of the state of the environment, the method comprising generating corresponding reward values for the actions using corresponding observations of the corresponding states of the environment before and following the performance of the actions by the agent, said iterative adjustment of the parameters of the policy model neural network being based on the reward values.

10. A method according to claim 1 in which said iterative adjustment of the parameters of the policy neural network increases the likelihood that an action selected by the action selection system based on the output of the policy model upon receiving an observation, increases an expected return which is a sum of reward values for a corresponding plurality of subsequent observations.

11. The method of claim 1 further comprising using the trained policy model neural network to control an agent to perform the task while interacting with the environment by using the trained policy model neural network to select actions to control the agent to perform the task.

12. The method of claim 1 in which the policy model neural network comprises a policy model encoder configured, upon receiving an observation, to form an encoded representation of the observation, the policy model neural network generating the output of the policy model neural network based on the encoded representation, the method further comprising training the policy model encoder by an encoder training process of iteratively modifying the policy model encoder to optimize the success rate of a prediction model which is trained, upon receiving encoded representations, produced by the policy model encoder, of two observations selected from the training database, to predict whether the two observations are observations which are part of the same trajectory and have a time difference between their respective the time steps which meets a criterion.

13. The method of claim 1 in which the progress model comprises a progress model encoder configured, upon receiving two observations, to form two respective encoded representations of each of two the observations, the progress model generating the progress value based on the two encoded representations, the method further comprising training the progress model encoder by an encoder training process of iteratively modifying the encoder to optimize the success rate of a prediction model which is trained, upon receiving encoded representations, produced by the progress model encoder, of two observations selected from the training database, to predict whether the two observations are observations which are part of the same trajectory and have a time difference between their respective the time steps which meets a criterion.

14. The method of claim 12 in which the encoder training process is performed prior to the training process.

15. (canceled)

16. (canceled)

17. (canceled)

18. (canceled)

19. A system comprising one or more computers and one or more storage devices storing instructions that when executed by the one or more computers cause the one or more computers to perform operations for training a policy model neural network of an action selection system configured to generate control data for controlling an agent interacting with an environment to perform a task, the policy model neural network being configured to receive input data comprising an observation characterizing the state of the environment and, based on the observation, to generate an output, the action selection system being configured to select an action for the agent to perform based on the output of the policy model neural network;
the operations employing:
a database of training data which comprises a plurality of trajectories, each trajectory comprising a sequence of observations characterizing consecutive states of the environment at corresponding time steps during a performance of the task, and
a progress model configured to generate an output upon receiving two observations as inputs;
the operations comprising:
based on the training data, training the progress model, upon receiving as inputs a pair of observations from one of the trajectories, to output a progress value indicative of the time difference between the time steps corresponding to the pair of observations; and
training the policy model neural network by iteratively adjusting parameters of the policy model neural network to increase the likelihood that an action selected by the action selection system based on the output of the policy model neural network upon receiving an observation, causes a subsequent observation having a high value of a reward value;
the reward value being the value of a reward function which includes an exploration reward term based on a progress value output by the trained progress model upon receiving as inputs a pair of observations characterizing the state of the environment at corresponding time steps which are respectively before and after the performance of the action.

20. One or more non-transitory computer storage media storing instructions that when executed by one or more computers cause the one or more computers perform operations for training a policy model neural network of an action selection system configured to generate control data for controlling an agent interacting with an environment to perform a task, the policy model neural network being configured to receive input data comprising an observation characterizing the state of the environment and, based on the observation, to generate an output, the action selection system being configured to select an action for the agent to perform based on the output of the policy model neural network;
the operations employing:
a database of training data which comprises a plurality of trajectories, each trajectory comprising a sequence of observations characterizing consecutive states of the environment at corresponding time steps during a performance of the task, and
a progress model configured to generate an output upon receiving two observations as inputs;
the operations comprising:
based on the training data, training the progress model, upon receiving as inputs a pair of observations from one of the trajectories, to output a progress value indicative of the time difference between the time steps corresponding to the pair of observations; and
training the policy model neural network by iteratively adjusting parameters of the policy model neural network to increase the likelihood that an action selected by the action selection system based on the output of the policy model neural network upon receiving an observation, causes a subsequent observation having a high value of a reward value;
the reward value being the value of a reward function which includes an exploration reward term based on a progress value output by the trained progress model upon receiving as inputs a pair of observations characterizing the state of the environment at corresponding time steps which are respectively before and after the performance of the action.

21. (canceled)

22. (canceled)

23. The non-transitory computer storage media according to claim 20 in which, for each action, the reward function additionally includes a reward term which is generated by comparing an observation of the state of the environment following the action to one or more criteria defining the task.

24. The non-transitory computer storage media according to claim 20 in which the progress value indicative of the time difference is proportional to a logarithmic function of the time difference.

25. The non-transitory computer storage media according to claim 24 in which the exploration reward term is an exponential function of the output of the progress model upon receiving the pair of observations.

26. The non-transitory computer storage media according to claim 20 in which comprises a step of filtering observations in the training data, prior to generating the progress model, to remove a part of each observation which is indicative of the corresponding time step.

27. The non-transitory computer storage media of claim 20 in which, in the training of the policy model neural network, the pair of observations characterize the state of the environment respectively at a first time step which is before the performance of the action and a second time step which is after the performance of the action, and the first time step is a predetermined number of time steps before the second time step.

28. The non-transitory computer storage media according to claim 20 in which the policy model neural network defines, for an observed state of an environment, a state-action distribution over a set of possible actions to be performed by an agent interacting with the environment to perform a task.
